(19) United States
(12) Patent Application Publication
(10) Pub. No.: US 2005/0242517 A1
(43) Pub. Date: Nov. 3, 2005

(54) Dynamic o-ring assembly

(75) Inventor: Fulvio Montipo, Reggio Emilia (IT)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Interpump Engineering S.R.L., Reggio Emilia (IT)

(21) Appl. No.: 11/084,285

(22) Filed: Mar. 18, 2005

Related U.S. Application Data
(60) Provisional application No. 60/554,595, filed on Mar. 19, 2004.

(51) Int. Cl. F16J 15/34

(52) U.S. Cl. 277/383

(57) ABSTRACT

The present disclosure is directed to an o-ring assembly adapted to fit between connected articles. The o-ring assembly includes a pliable ring and a less pliable but lower friction support ring. The pliable ring includes a first generally flat surface and a curved outer surface. The support ring includes a pair of opposing surfaces. One of the opposing surfaces is adapted to interface with the generally flat surface of the pliable ring and the other of the opposing surfaces is adapted to interface with the at least one of the articles.

### CROSS REFERENCE TO RELATED APPLICATIONS

This application claims the benefit of prior U.S. Application No. 60/554,595, which was filed on Mar. 19, 2004.

### BACKGROUND

The present disclosure is directed to an o-ring structure that is adapted to form a generally fluid-tight seal between a plurality of articles. More particularly, the present disclosure is directed to a dynamic o-ring assembly that is adapted to move in a direction of the plane of the o-ring.

Two categories of o-rings include static and dynamic o-rings. Static o-rings are typically wedged between two articles and compressed. The static rings form a seal only because they are of a malleable material that deforms when a compressive force is applied. Dynamic o-rings are also compressed but to a lesser extent. A dynamic o-ring is one that is deployed so as to use the outer and inner sides of the ring to make a seal. A dynamic o-ring is used in applications that include where the o-ring is subjected to alternating suction and pressure forces. The alternating forces place alternating outward and inward forces on the o-ring, causing the ring to expand and contract in a plane of the ring. The movement of the o-ring deems it a dynamic, rather than static, o-ring.

One illustrative example particularly suitable for a dynamic o-ring is in a reciprocating positive displacement plump. A reciprocating positive displacement pump first moves fluids into the pump, and then the fluids are moved out of the pump. Plunger pumps are reciprocating positive displacement pumps that displace a given amount of fluid on each cycle, or stroke, of the plunger. The reciprocating motion of the plunger, with check valves on each side of the pump body, creates the pumping action of the fluid. On the suction stroke, low pressure in the pump body closes a discharge check valve, opens a suction check valve, and pulls fluid into a pump cylinder in one example. On the discharge stroke, high pressure in the pump body closes the suction check valve, opens the discharge check valve, and pushes the fluid out of the pump cylinder in the example. Typically, these pumps include one to six cylinders, and a common configuration is a triplex pump with three cylinders, two check valves per cylinder, and an o-ring disposed between each check valve and its respective cylinder to form a seal. Accordingly, each o-ring experiences alternating suction and pressure forces. For a given o-ring during one of the strokes, high pressure is generated on the inside of the ring, forcing the ring against an inner wall of the cylinder, thereby forming an effective seal between the outside of the ring and the inner wall of cylinder. On the other stroke, a suction force is created that draws the o-ring inward, to a compressed configuration.

A dynamic ring, rather than a static ring, in such applications as the plunger pump can result in a more effective seal and a longer-lasting ring. The longer life and more effective seal are attributable to the reduction in the amount of compressive force placed on the ring. However, the presently available o-ring designs are less than optimal for such applications. If the o-ring were static and unable to move, for example, the fluid forces would not assist the o-ring in making the seal. Rather, the fluid would be trying to work its way around the o-ring. The dynamic o-ring moves more than a static o-ring. Thus, while avoiding much of the damaging compressive forces felt by the static o-ring, the dynamic o-ring tends to wear due to the inward and outward movement when employed in a rapidly changing environment such as alternating stroke cycles. It has been determined that because the o-rings that were being used had a round cross-section, they were rolling back and forth during the stroke cycles, and wearing more quickly as a result.

In order to encourage the rings to slide rather than roll, o-rings having round cross-sections were replaced with those having square cross-sections. This replacement was effective at reducing wear due to rolling, however, during assembly, the squared corners tended to get caught on internal threads protruding from the inside surface into which the rings were place. Often, the rings were impeded prior to achieving their intended operating space and destroyed when the successive assembly step was attempted. Also, the haste in which parts were assembled in a production setting often resulted in excessive wearing of the squared corners as they passed against the threads in route to proper placement.

Further, the dynamic o-rings exhibit wear against the bottom surface, or article interface surface, even when the rings are properly placed. This wear is partly due to the constant rubbing along the bottom surface and partly due to the high temperatures and resulting cavitations. Cavitation is the release of gas by a solution due to an abrupt pressure drop. The gas is released so quickly, the individual gas molecules are sufficient in number to coalesce and form extremely low-pressure gas bubbles. As soon as the low fluid pressure condition subsides, the bubbles violently implode, creating noise and sufficient force to damage nearby materials. Cavitation occurs more readily in high temperature environments. One high temperature environment includes car wash systems or other industrial cleaning applications using plunger pumps where the water temperature is often greater than approximately 165 degrees (about 74 degrees Celsius) Fahrenheit and often up to approximately 185 degrees Fahrenheit (about 85 degrees Celsius). O-rings in such applications are subjected to significant cavitation that substantially decreases the lifespan of the rings.

Accordingly there is continuing need to provide an o-ring that does not roll during pressure cycles, is not damaged during assembly, resists wearing on its sliding surface, and is useable in a high-temperature application without being damaged by cavitation.

### SUMMARY

The present disclosure is directed to an o-ring assembly adapted to fit between a plurality of articles. The o-ring assembly includes a pliable ring and a less pliable but lower friction support ring. The pliable ring includes a first generally flat surface and a curved outer surface. The ring is disposed in a plane and includes a cross section. The cross section includes a curved portion that extends in a direction generally perpendicular to the plane, and this curved portion of the cross section corresponds with the curved outer surface. The cross section further includes a generally linear portion that extends in a direction generally parallel to the plane, and this linear portion corresponds with the generally flat surface. The support ring includes a pair of opposing surfaces. One of the opposing surfaces is adapted to interface with the generally flat surface of the pliable ring and the other of the opposing surfaces is adapted to interface with the at least one of the articles.

The present disclosure includes several aspects. One of the aspects includes an assembly having an o-ring with a particular unique shape and a novel protective support ring. In order to prevent rolling, the o-ring includes flat sides on an upper and lower surface of the ring. In order to prevent damage, round outer and inner edges have been preserved. The support ring is a flat ring, having a relatively low coefficient of friction against the o-ring, and placed between the o-ring and a cylinder head or wall, for example. This protects the o-ring as it expands and contracts. In one example, the support ring is constructed of a mixture of PTFE and bronze and provides a softer, more cushioned support than the metal cylinder head.

### BRIEF DESCRIPTION OF THE DRAWINGS

FIG. 1 is a schematic drawing of an environment of the present disclosure.

FIG. 2 is a cross-sectioned plan view of a plunger pump including features of the present disclosure.

FIG. 3 is a perspective exploded view of an example o-ring assembly in connection with a portion of the pump of FIG. 2.

FIG. 4 is a sectional side view of the o-ring assembly of FIG. 3 and including a magnified view of the o-ring assembly.

FIG. 5 is a sectional side view of another example o-ring assembly.

FIG. 6 is a sectional side view of still another example o-ring assembly.

### DETAILED DESCRIPTION

This disclosure relates to o-ring assemblies. The disclosure, including the figures, describes the o-ring assemblies with reference to illustrative examples. For example, the disclosure proceeds with respect to an o-ring assembly used with a valve assembly in a plunger pump mechanism. However, it should be noted that the present invention could be implemented in other systems or pump mechanisms, as well. The disclosure also proceeds with respect to particular configurations or shapes for illustrative purposes only. Other examples are contemplated and are mentioned below or are otherwise imaginable to someone skilled in the art. The scope of the invention is not limited to the few examples, i.e., the described embodiments of the invention. Rather, the scope of the invention is defined by reference to the appended claims. Changes can be made to the examples, including alternative designs not disclosed, and still be within the scope of the claims.

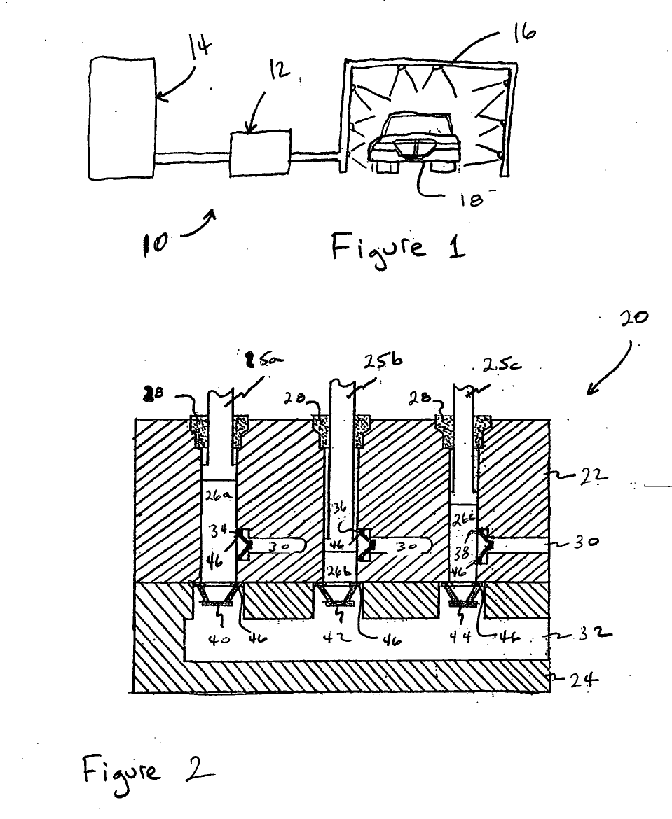

FIG. 1 shows a schematic view of a car wash 10, which is one example of an environment of the present disclosure. The car wash can include an automatic, manual, or conveyor type car wash. Other types of industrial cleaning systems are also suitable for the present environment. The car wash 10 includes a pump 12 coupled to a heated water supply 14 and receives water from the water supply 14. Typically, the water supply 14 can be heated to approximately 185 degrees Fahrenheit (about 85 degrees Celsius) and the pump 12 is adapted for high temperature conditions, and possibly for high-pressure conditions. The pump 12 provides the water to nozzles 16 that are adapted to spray the water onto a vehicle 18 in the car wash 10.

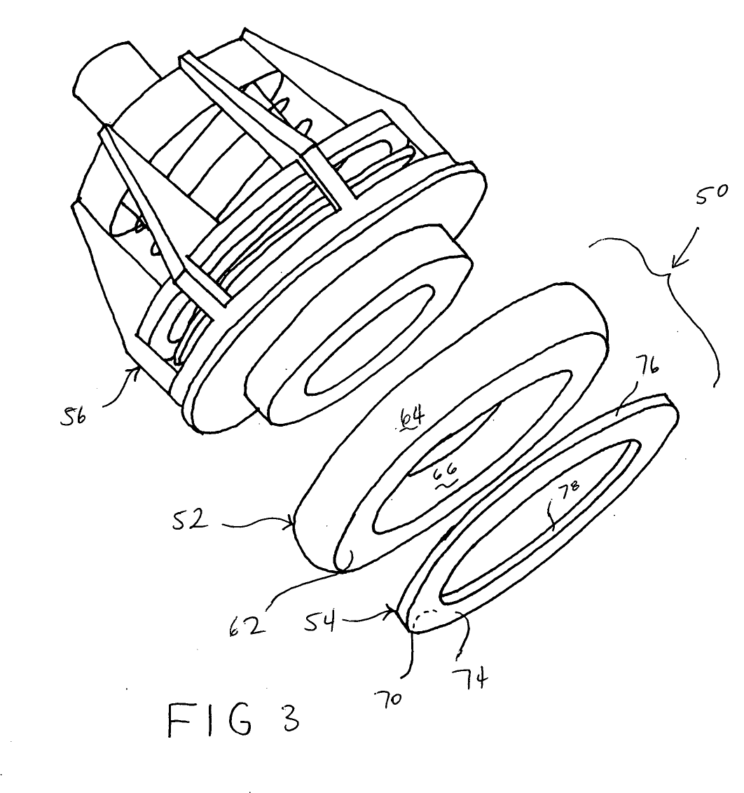

FIG. 2 shows a general schematic diagram of a pump 20, such as one suitable for use in the car wash system 10 or other application. The pump 20 includes a pump housing 22 and an outlet manifold 24. A first plunger 25a, second plunger 25b and third plunger 25c are illustrated in this example. The plungers 25a, 25b, 25c, extend within a first chamber 26a, second chamber 26b and third chamber 26c, respectively. The chambers, or cylinders, also include seal stacks 28. The pump 20 has an inlet 30 for providing a supply of fluid, and an outlet 32 for providing the pressurized fluid to subsequent devices, such as the nozzle 18. In the example, the housing 22 is configured so that housing inlet 30 is in communication with first chamber 26a, second chamber 26b and third chamber 26c, so that fluid can be provided to each of these chambers. The pump also includes a plurality of check valve assemblies. In the example, two check valve assemblies are coupled to each chamber. A first inlet check valve assembly 34 is disposed proximate the first chamber 26a near the inlet. Similarly, a second inlet check valve assembly 36 and a third inlet check valve assembly 38 are disposed proximate the first and second chambers 26b, 26c, respectively. Each chamber 26a, 26b, 26c also has an appropriate outlet check valve assembly. Chamber 26a includes a first outlet valve 40, chamber 26b includes a second outlet valve 42, and chamber 26c includes a third outlet valve 44. An o-ring assembly 46 is disposed between each check valve assembly and its respective cylinder.

Both the inlet valves 34, 36, 38 and the outlet valves 40, 42, 44 are one-way pressure activated valves which operate to allow fluid to move one direction while prohibiting its movement in an opposite direction. Fluid is drawn into the first chamber 36a when the first plunger 25a is in a down stroke. The negative pressure within the chamber 26a causes the inlet check valve assembly 34 to open and fluid enters the chamber 26a from the inlet 30. The corresponding o-ring assembly 46 contracts generally in a direction of the plane of the o-ring, i.e., in a direction generally perpendicular to the fluid flow. Negative pressure within the chamber 26a also causes the outlet check valve assembly 40 to close, so fluid does not exit the chamber 26a into the outlet 32. Fluid exits the first chamber 26a when the first plunger 25a is in an upstroke. The positive pressure within the chamber 26a causes the outlet check valve assembly 40 to open and fluid exits the chamber 26a into the outlet 32. The corresponding o-ring assembly 46 expands generally in a direction of the plane of the o-ring. The positive pressure within the chamber 26a also causes the inlet check valve assembly 34 to close, so fluid does not enter the chamber 26a from the inlet 30. The motion of the o-ring assembly 46 creates a dynamic seal.

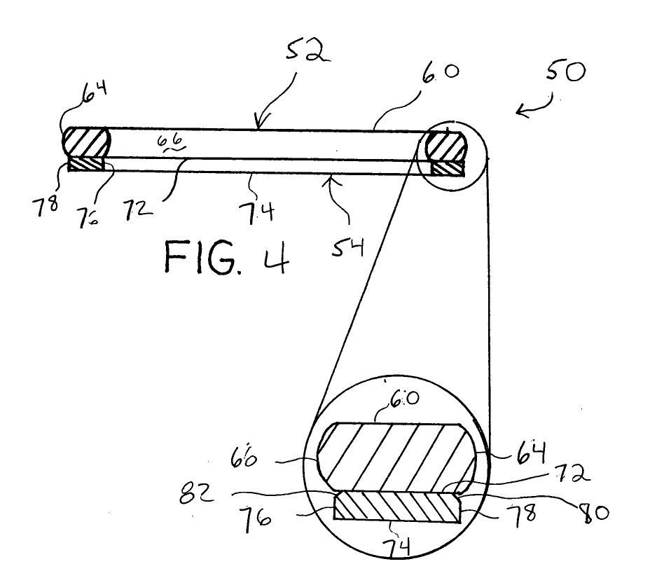

FIGS. 3 and 4 shows a more detailed view of an o-ring assembly 50, which is an example of the o-ring assembly 46 described above. The o-ring assembly 50 includes an o-ring 52 and a support ring 54. An example check valve assembly 56 is also shown to provide context for the o-ring assembly 50 and a possible application for the o-ring assembly 50. The o-ring assembly 50 is adapted to be disposed between the check valve assembly 56 and a wall of the pump proximate the inlet 30 or the outlet 32. In one example, the o-ring creates a generally fluid tight seal between a plurality of articles such as the check valve 56 and the pump wall. “Generally fluid tight” refers to a seal that has a leakage rate low enough to not interfere with the operation of the articles, such as the check valve and pump wall. One skilled in the art will realize, however, the vast array of uses for the o-ring assembly 50.

The o-ring 52 can be constructed in a variety of configurations. The o-ring 52 is shown as generally circular, but can be constructed to have other curvilinear shapes. The o-ring 52 includes at least one, but preferably two opposing flat surfaces 60 and 62 and a rounded outer surface 64. The o-ring can also include an inner surface 66, which in the example shown is also rounded but may be flat. As can be seen in the cross sectional view of FIG. 4, the rounded outer and inner surfaces 64, 66 each extend in a direction generally perpendicular to the diameter of the o-ring 52, or plane of the o-ring. The opposing surfaces 60, 62 extend in a direction generally parallel to the diameter of the o-ring 52. In order to create an effective seal, the o-ring 52 is preferably constructed of a sufficiently pliable material. In one example, the material is rubber.

The slide or support ring 54 is formed of a less pliable material than the o-ring 52 and acts as a support for the o-ring 52. In one example, the support ring is formed form a material including polytetrafluoroethylene (PTFE). PTFE is sold under several trade designations, such as TEFLON available from General Electric Co. of Fairfield, Conn., U.S.A. Preferably, the support ring 54 is formed of a material including a mixture of PTFE and bronze. Adding bronze to PTFE provides more strength and gives the ring 54 a low coefficient of friction.

The support ring 54 can include a variety of configurations. In the example, the support ring 54 includes a flat surface 70 that acts against and interfaces with the flat surface 62 of the o-ring 52. The flat surface 70 of the support ring 54 and the flat surface 62 of the o-ring 52 together form a low-friction interface 72. The support ring 54 also has an opposite surface 74 that acts against a surface of the part to which the object part, in this case valve assembly 56, is to be attached or sealed against, such as the inlet or outlet wall of the pump. The opposing surface 74 is preferably flat, as shown, for economic purposes but may be shaped to mate with the surface against which it will be placed in operation. Similarly, the support ring 54 has an outer surface 76 and an inner surface 78, which are also preferably flat but may be any appropriate shape. As seen in FIG. 4, the support ring 54 has an outer edge 80 and an inner edge 82 that are proximate the flat surface 70. It is preferable that the outer edge 80 is beveled or rounded, or otherwise non-squared corners, to minimize wear on the flat surface 62 of the o-ring 52 as the o-ring 52 expands and contracts over the outer edge 80. The inner edge 82 can also be beveled or rounded.

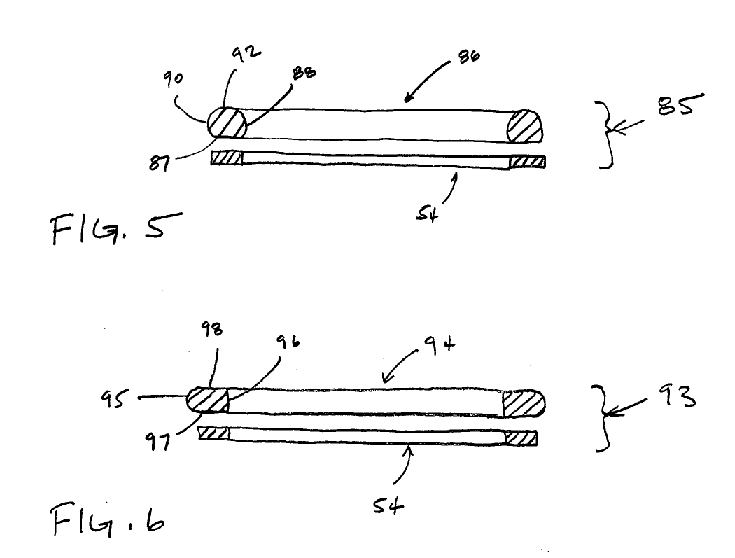

FIG. 5 shows another example of an o-ring assembly 85, where like parts include like reference numbers. The o-ring assembly includes o-ring 86 and support ring 54, which is similar to that shown above. The o-ring 86 includes a single flat surface 87, where as the inner surface 88, outer surface 90 and opposite surface 92 are rounded and the cross section includes corresponding curved portions.

FIG. 6 shows still another example of an o-ring assembly 93, where like parts include like reference numbers. The o-ring assembly includes o-ring 94 and support ring 54, which is similar to that shown above. The o-ring 94 includes a single curved surface, corresponding with the curved outer portion 95 of the cross section, where as the inner surface 96, and opposite surfaces 97, 98 are flat and the cross section includes corresponding linear portions.

The present invention has now been described with reference to several embodiments. The foregoing detailed description and examples have been given for clarity of understanding only. Those skilled in the art will recognize that many changes can be made in the described embodiments without departing from the scope and spirit of the invention. Thus, the scope of the present invention should not be limited to the exact details and structures described herein, but rather by the appended claims and equivalents.

1. An assembly adapted to fit between a plurality of articles, wherein at least one of the articles includes a coefficient of friction above a selected threshold amount, the assembly comprising:
a generally pliable ring member having a first generally flat surface and a curved outer surface, the ring member disposed in a plane, wherein the ring member includes a cross section including a curved surface extending at least in a direction generally perpendicular to the plane corresponding with the curved outer surface, and the cross section further including a generally linear surface extending in a direction generally parallel to the plane corresponding with the generally flat surface; and
a support ring member having a pair of opposing surfaces, wherein one of the pair of opposing surfaces is adapted to interface with the generally flat surface of the ring member and the other of the opposing surfaces is adapted to interface with the at least one of the articles, and wherein the support ring member includes a coefficient of friction below the selected threshold amount.

2. The assembly of claim 1 wherein the ring member is circular.

3. The assembly of claim 1 wherein the ring member includes a curved inner surface.

4. The assembly of claim 3 wherein the ring member includes a pair of flat surfaces.

5. The assembly of claim 3 wherein the ring member includes only one flat surface.

6. The assembly of claim 1 wherein the ring member includes three flat surfaces.

7. The assembly of claim 1 wherein the support ring includes a material having PTFE.

8. The assembly of claim 7 wherein the material further includes bronze.
